(19) United States
(12) Patent Application Publication
(10) Pub. No.: US 2009/0016739 A1
(43) Pub. Date: Jan. 15, 2009

(54) PATTERN EFFECT REDUCTION OF OPTICAL SIGNALS

(75) Inventors: Jianjun Yu, Stone Mountain, GA (US); Lei Xu, Princeton, NJ (US); Philip Nan Ji, Plainsboro, NJ (US); Ting Wang, Princeton, NJ (US)

Correspondence Address: BROSEMER, KOLEFAS & ASSOCIATES, LLC (NECL), ONE BETHANY ROAD BUILDING 4 - SUITE #58, HAZLET, NJ, 07730, US

(73) Assignee: NEC LABORATORIES AMERICA, Princeton, NJ (US)

(21) Appl. No.: 11/830,987

(22) Filed: Jul. 31, 2007

Related U.S. Application Data
(60) Provisional application No. 60/820,830, filed on Jul. 31, 2006.

(51) Int. Cl. H04B 10/00

(52) U.S. Cl. 398/158

(57) ABSTRACT

A passive optical equalizer and a predistortion technique are employed to reduce pattern effect in optical signals which result from narrow filtering.

### CROSS REFERENCE TO RELATED APPLICATIONS

This application claims the benefit of U.S. Provisional Application No. 60/820,830 filed Jul. 31, 2006 the entire contents of which are incorporated by reference as if set forth at length herein.

### FIELD OF THE INVENTION

This invention relates generally to the field of optical communications and in particular to a method of reducing a pattern effect experienced in optical communications systems caused by the narrow filtering of optical signals.

### BACKGROUND OF THE INVENTION

One of the challenges faced when upgrading 10 Gbit/s 50 GHz-spacing dense wavelength division multiplexed (DWDM) systems to 40 Gbit/s is caused by a pattern effect resulting from narrow filtering by optical multiplexers and de-multiplexers. As a result, methods and/or apparatus that mitigate these pattern effects would represent a significant advance in the art.

### SUMMARY OF THE INVENTION

An advance is made in the art according to the principles of the present invention in which pattern effects are reduced in DWDM systems.

Viewed from a first aspect, the present invention employs an optical equalizer to mitigate the pattern effect. Advantageously, both return-to-zero (RZ) and non-return-to-zero (NRZ) intensity/phase modulated signals may be produced.

Viewed from a second aspect, the present invention adjusts the DC bias on an intensity modulator to generate a distorted signal which in turn is used to generate an intensity modulated signal.

### BRIEF DESCRIPTION OF THE DRAWING

A more complete understanding of the present invention may be realized by reference to the accompanying drawing in which:

FIG. 1 shows a graph of optical spectra of 40 Gbit/s RZ signal before and after passing through 50/100 GHz optical interleaver;

FIG. 2 pattern and eye diagram of 40 Gbit/s NRZ signals passing through a 50/100 GHz optical interleaver. FIG. 2(A) Pattern (100 ps/div), FIG. 2(B) eye diagram (10 ps/div);

FIG. 3 is a graph of the optical spectra for FIG. 3(A) The transfer function of the OEQ; and FIG. 3(B) the transfer function of optical interleaver, and cascaded optical interleaver and OEQ;

FIG. 4 is a block diagram showing optical equalizers used to mitigate pattern effect on optical signals and experimental arrangement;

FIG. 5 shows eye diagrams of regular 40 Gbit/s NRZ signals (10 ps/div) for FIG. 5(A) original, and FIG. 5(B) passing through 50/100 GHz optical interleaver, (c) passing through optical interleaver and OEQ;

FIG. 6 is a graph showing BER curves for 40 Gbit/s NRZ signals;

FIG. 7 shows eye diagrams of regular 40 Gbit/s RZ signals (10 ps/div) for FIG. 7(A) original, and FIG. 7(B) passing through 50/100 GHz optical interleaver, FIG. 7(C) passing through optical interleaver and OEQ;

FIG. 8 shows BER curves for 40 Gbit/s RZ signals;

FIG. 9 is block diagram showing an experimental setup for using OEQ to reduce pattern effect for phase modulation 40 Gbit/s signals according to the present invention;

FIG. 10 shows eye diagrams of regular 40 Gbit/s NRZ-DPSK signals (10 ps/div) for FIG. 10(A) Original, FIG. 10(B) passing through 50/100 GHz optical interleaver, and FIG. 10(C) passing through optical interleaver and OEQ.

FIG. 11 shows BER curves for 40 Gbit/s NRZ signals;

FIG. 12 show eye diagrams of regular 40 Gbit/s RZ-DPSK signals (10 ps/div) for FIG. 12(A) original, FIG. 12(B) passing through 50/100 GHz optical interleaver, and FIG. 12(C) passing through optical interleaver and OEQ.

FIG. 13 shows BER curves for 40 Gbit/s RZ signals;

FIG. 14 depicts principles for generating a distorted input signal according to the present invention;

FIG. 15 is distorted optical eye diagram generated by adjusting DC bias (10 ps/div) according to the present invention;

FIG. 16 shows 40 Gbit/s NRZ eye diagrams (10 ps/div) for FIG. 16(A) Original good eye, FIG. 16(B) good eye passing through 50/200 GHz interleaver, FIG. 16(C) original distorted eye, and FIG. 16(D) distorted eye passing through 50/200 GHz interleaver;

FIG. 17 show transfer functions of two different 50 GHz inter-leaver;

FIG. 18 shows BER curves for 40 Gbit/s NRZ signals;

FIG. 19 shows 40 Gbit/s RZ eye diagrams (10 ps/div) for FIG. 19(A) Original good eye, FIG. 19(B) good eye passing through 50/200 GHz interleaver, FIG. 19(C) original distorted eye, FIG. 19(D) distorted eye passing through 50/200 GHz interleaver; and

FIG. 20 shows BER curves for 40 Gbit/s NRZ signals.

### DETAILED DESCRIPTION

The following merely illustrates the principles of the invention. It will thus be appreciated that those skilled in the art will be able to devise various arrangements which, although not explicitly described or shown herein, embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the invention.

The following references may provide additional useful background information for which purposes they are incorporated herein by reference: [1] Wei Wang, Lavanya Rau and Daniel J. Blumenthal, “All-Optical Label Switching/Swapping of 160 Gbps Variable Length Packets and 10 Gbps Labels using a WDM Raman Enhanced-XPM Fiber Wavelength converter with Unicast/Multicast Operation”, in Proc. Optical Fiber Communications (OFC2004), Los Angeles, Calif., 2004: PDP8; [2] N. Deng, Y. Yang, et al., “All-optical OOK label swapping on OFSK payload in optical packet networks”, in Proc. Optical Fiber Communications (OFC2004), Los Angeles, Calif., 2004: FO5; [3] X. Liu, X. Wei, Y. Su, J. Leuthold, Y. Kao, I. Kang and R. C. Giles, “Transmission of an ASK-labeled RZ-DPSK signal and label erasure using a saturated SOA”, IEEE Photon. Technol. Lett., Vol. 16, No. 6, 2004: 1594-1596; [4] J. Yu, G. K. Chang, A. Chowdhury and J. L. Long, “Spectral efficient DWDM optical label/payload generation and transport for next generation internet”, IEEE/OSA Journal of Lightwave Technology, 2004, vol. 22, no. 11, pp: 2469-2482; [5] J. Yu, G. K. Chang, and Q. Yang, “Optical label generation, erasure, and reinsertion in a packet switched optical network using optical carrier suppression, separation, and wavelength conversion”, IEEE Photon. Technol. Lett., vol. 16, no. 9, 2004: 2156-2158; [6] S. J. B. Yoo, Y. Bansal, Z. Pan, J. Cao, V. K. Tsui, S. K. H. Fong, Y. Zhang, J. Taylor, H. J. Lee, M. Jeon and V. Akella, “optical label based packet routing system with contention resolution in wavelength, time and spacing domains”, in Proc. Optical Fiber Communications (OFC2002), WO2; [7] T. Koonen, G. Morthier, et al., “Optical packet routing in IP-over-WDM networks deploying two-level optical labeling”, in Proc. Eur. Conf. Optical Commun. (ECOC2002), Copenhagen, Denmark, 2002, paper 5.5.2[8] J. Yu and G. K. Chang, “A novel technique for optical label and payload generation and multiplexing using optical carrier suppression and separation”, IEEE Photon. Technol. Lett., Vol. 16, No. 1, 2004: 320-322; [9] J. Yu and G. K. Chang, “Label Erasure Using an Imbalanced NOLM and its Application in a 40 Gbit/s Label Switching Optical Network”, OFC 2005, OTuC3; [10] A. Chowdhury, J. Yu and G. K. Chang, “A Novel Optical Label Swapping Scheme for DPSK Data Transmissions Using Optical Carrier Suppression and Separation Technique”, OFC 2005, OTuC4; [11] G. K. Chang and J. Yu, “Multi-rate payload switching using a swappable optical carrier suppressed label in a packet switched DWDM optical network”, OFC 2004: PDP5; [12] J. Yu, et al., “Novel techniques for generation of high-spectral efficiency and high receiver sensitivity optical packet”, OFC 2006; [13] H. Chen, M. Chen, Y. Dai, S. Xie, and B. Zhou, “All-optical labeling scheme with vestigial sideband payload”, Optics Express, Vol. 13, No. 7, 2005: 2282-2288; [14] D. F. Grosz, et al, “5.12 Tbit/s (128*42.7 gbit/s) transmission with 0.8 bits/s/Hz spectral efficiency over 1280 km of standard single mode fiber using all-Raman amplification and strong signal filtering”, ECOC 2002, PD4.3, 2002; [15] G. Charlet, et al, “Cost-optimized 6.3 Tbit/s capacity terrestrial link over 17*100 km using phase-shaped binary transmission in a conventional all-EDFA SMF-based system”, OFC 2003, PD25-1, 2003; [16] B. Zhu, et al, “6.4 Tb/s (160*42.7 Gbit/s) transmission with 0.8 bits/s/Hz spectral efficiency over 32*100 km of fiber using CSRZ-DPSK format”, OFC 2003, PDP19-1, 2004; [17] A. H. Gnauck, et al, “Spectral efficiency (0.8 b/s/Hz) 1 Tb/.s (25*42.7 Gb/s) RZ-DQPSk transmission over 28 100-km SSMF with 7 optical add.drops”, ECOC 2004, Th4.4.1, 2004; [18] A. H. Gnauck, P. J. Winzer, “Optical phase-shift-keyed transmission”, Journal of Lightwave Technology, v 23, pp 115-130, 2005; [19] X. Liu, “Can 40-Gb/s Duobinary Signals be Carried Over Transparent DWDM Systems With 50-GHz Channel Spacing?”, IEEE Photonics Technology Letters, v 17, pp 1328, 2005; [20] L. Xu, et al, “Advanced DPSK demodulators for 40 Gb/s WDM systems: colorless type”, NEC Technical Report, 2005; [21] M. Birk, B. Mikkelsen, “40 Gb/s upgrades on existing 10 Gb/s transport infrastructure”, Optics East 2005, paper 6012-14; [22] P. M. A. Charrua, A. V. T. Cartaxo, “Optimized filtering for AMI-RZ and DCS-RZ SSB signals in 40-Gb/s/ch-based UDWDM systems”, IEEE Photonics Technology Letters, v 17, pp 223, 2005; [23] S. Bigo, “Multiterabit/s DWDM terrestrial transmission with bandwidth-limiting optical filtering”, IEEE Journal of Selected Topics in Quantum Electronics, v 10, pp 329, 2004; [24] G. S. Kanter, A. K. Samal, A. Gandhi, “Electronic dispersion compensation for extended reach”, OFC 2004, paperTuG1, 2004; [25]C. R. Doerr, et al, “Simple Multichannel Optical Equalizer Mitigating Intersymbol Interference for 40-Gb/s Nonreturn-To-Zero Signals”, Journal of Lightwave Technology, v22, pp 249, 2004; [26] H. L. An, et al, “Multi-wavelength operation of an erbium-doped fiber ring laser using a novel dual-pass Mach-Zehnder comb filter”, Optics Communications, v 169, pp 159, 1999; [27] A. Bellemare, et al, “Room temperature multifrequency erbium-doped fiber laser anchored on the ITU frequency grid”, Journal of Lightwave Technology, v 18, pp 825, 2000; [28] X. J. Gu, “Wavelength-division multiplexing isolation fiber filter and light source using cascaded long-period fiber grating”, Optics Letters, v23, pp 509, 1998; [29] X. Fang, et al, “Polarization-independent fiber wavelength division multiplexer based on a Sagnac interferometer”, Optics Letters, v20, pp 2146, 1995; [30]A. Yariv, “Optical Electronics in Modern Communications”, 5th edition, 1997; [31] E. IP, et al, “40 Gbit/s Per Channel Fiber Optic Transmission at 0.8 bits/s/Hz”, NEC Labs America Technical Report, 2005; and [32] L. Xu, et al., “multi-channel optical equalization filters for ISI suppression in DWDM communication systems”, NEC Labs America Technical Report 2005-L185.

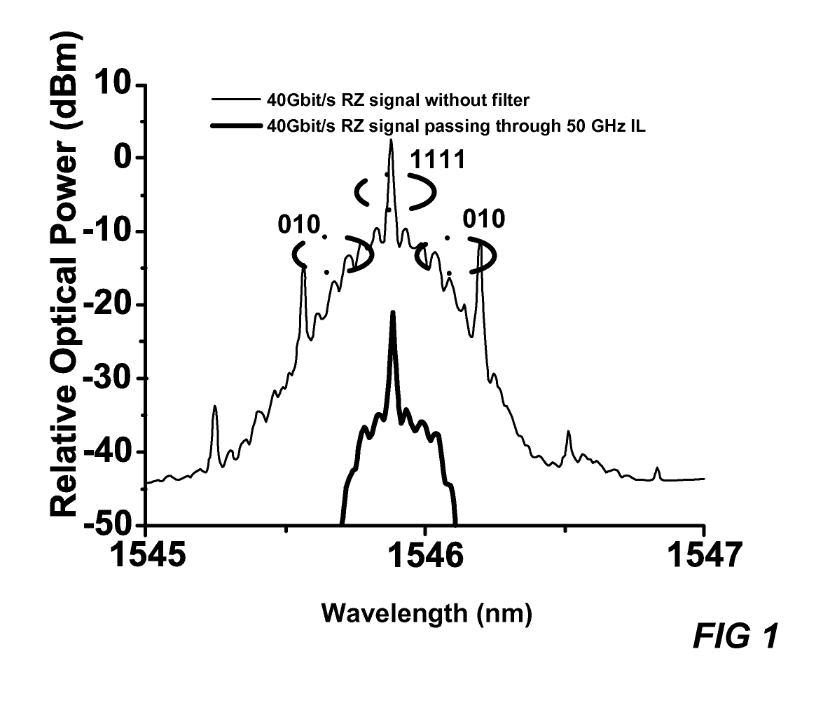

By way of some additional background, we may show the origins of the pattern effect which is the subject of the instant invention. More particularly, and with reference to FIG. 1, there is shown a graph of a regular RZ signal spectrum before and after passing through a 50/100 GHz optical interleaver. As known by those skilled in the art, consecutive “1”s and isolated “1”s have different spectral components. In particular, more DC components exist in the consecutive “1”s, while for the isolated “1”s, the DC components are small but the high frequency components are large.

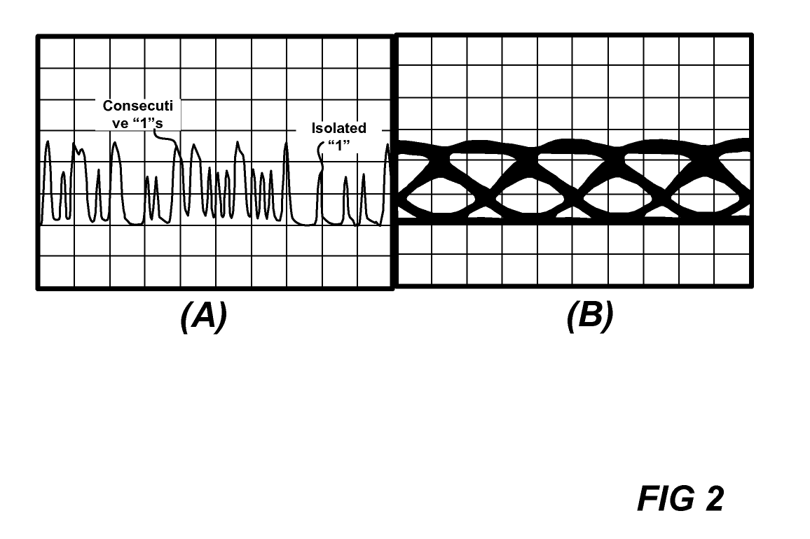

In optical communications, high frequency components will typically exhibit longer or shorter wavelengths than the center wavelength after optical-to-electrical (O/E) conversion. When a 40 Gbit/s signal passes through a narrow band optical filter, the high frequency components will be suppressed, but the DC components are well maintained. As a result, a pattern effect such as that shown in FIG. 2 is produced. As shown in that FIG. 2(A), it may be observed that isolated “1”s exhibit a small amplitude, while consecutive “1”s exhibit a high amplitude. FIG. 2(B) is an eye diagram that shows that the eye opening is reduced as a result of pattern effect; therefore the receiver sensitivity will be degraded.

From this we know that the observed pattern effect results from the fact that the high and low frequency components exhibit a different loss when the 40 Gbit/s signals pass through a narrow band optical filter. In particular, the low frequency components or the signals at the center wavelength have a smaller loss. As a result, and according to the principles of the present invention—an optical equalizer (OEQ) may be employed to increase the loss for signals at the lower frequency. Consequently, the signals at both the lower and higher frequencies will exhibit substantially the same loss when they pass through the cascaded narrow bandwidth interleaver and OEQ.

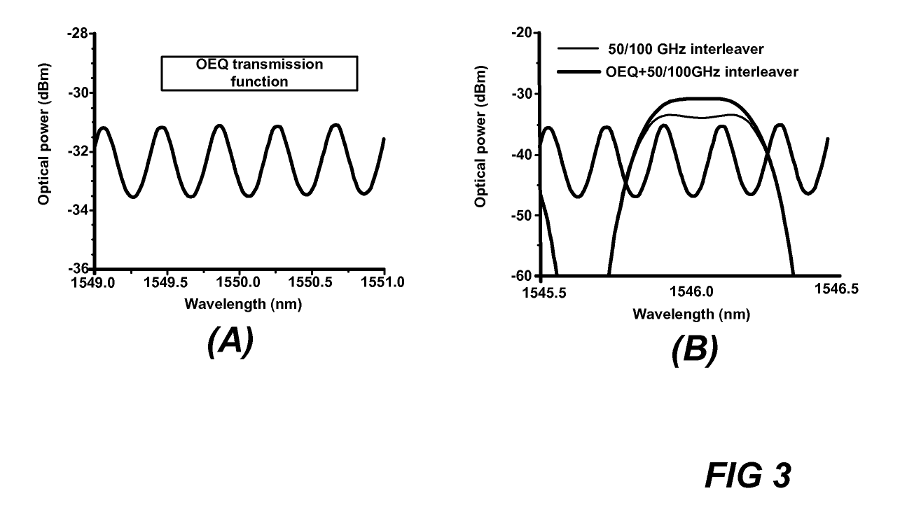

Turning now to FIG. 3 (A), there it shows a transfer function for an OEQ constructed according to the principles of the present invention. In this example, the OEQ exhibits a 100 GHz free space range (FSR), a 2.5 dB dip which those skilled in the art will readily appreciate will preferably match the ITU-T wavelength.

With reference to FIG. 3 (B), there it shows a transfer function of an optical interleaver exhibiting a 50 GHz channel spacing and 3 dB bandwidth of 0.4 nm. When cascaded with the OEQ, we may observe that the center wavelength has a dip around 2.5 dB. Advantageously, this dip can be used to reduce the pattern effect for 40 Gbit/s signals.

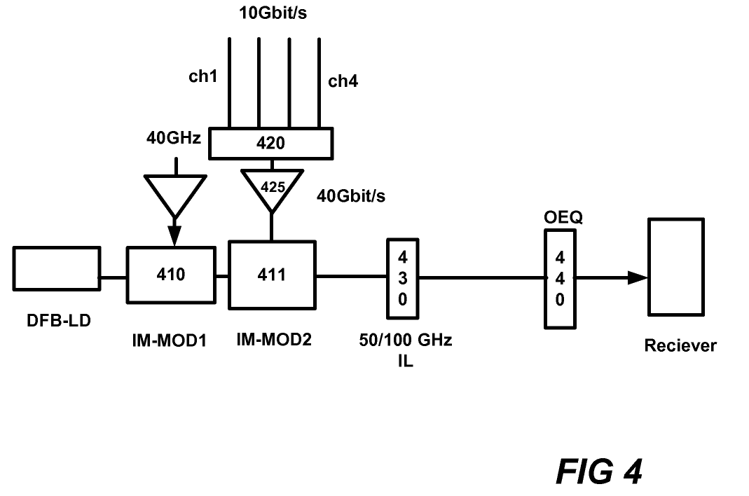

Turning our attention now to FIG. 4, there is shown an exemplary setup for using OEQ to reduce pattern effect for regular intensity modulation signals according to the present invention. More particularly, the exemplary experimental setup shown is for using an OEQ 440 to reduce the pattern effect for 40 Gbit/s NRZ signals. As shown therein, two cascaded intensity modulators 410, 411 are used to generate return-to-zero 40 Gbit/s signals having a duty cycle of 0.4. In the situation where non-return-to-zero signal generation is desired, the first modulator 410 is removed.

The 40 Gbit/s electrical signals are generated by a 1:4 electrical multiplexer 420. After multiplexing, an electrical amplifier 425 exhibiting an output amplitude of 7V to drive the intensity modulator 411 thereby realizing O/E conversion and the generation 40 Gbit/s optical signals. The PRBS for the 10 Gbit/s signals before multiplexing is 2³¹−1. The interleaver 430 has a channel spacing of 50 GHz.

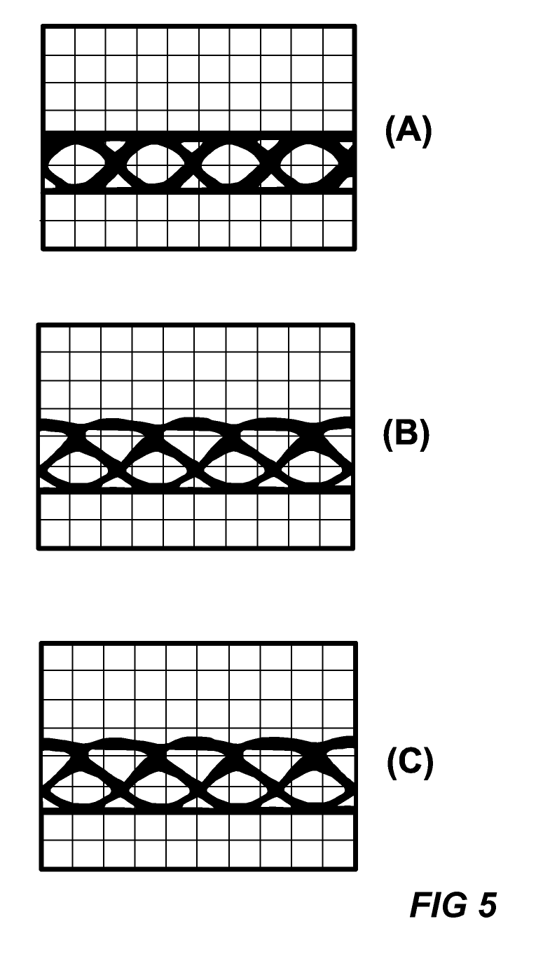

Turning now to FIG. 5 which shows the eye diagrams after the 40 Gbit/s NRZ signals are passed through the optical interleaver and OEQ apparatus shown in FIG. 4. More particularly, by inspection of FIGS. 5(A), 5(B), and 5(C) one can see that OEQ reduces the pattern effect and enhances eye opening.

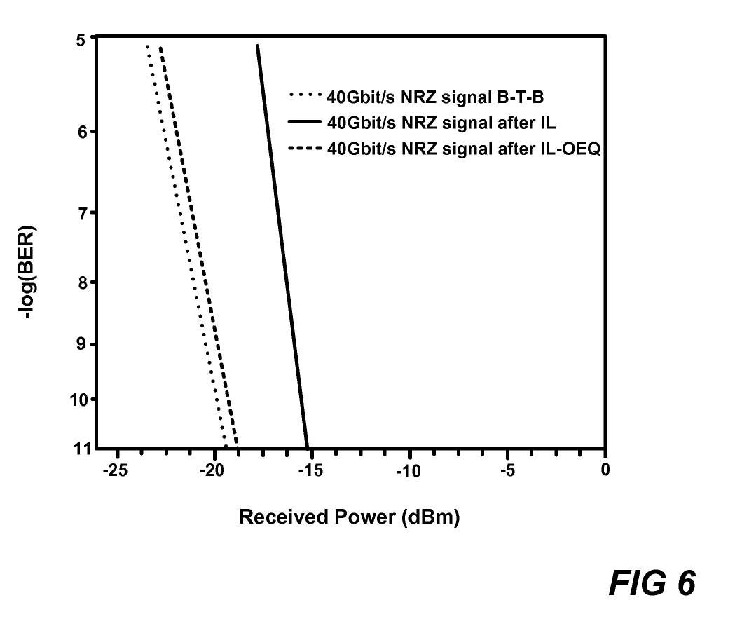

FIG. 6 is a graph showing shows the BER performances. As can be observed from this graph, receiver sensitivity has been enhanced by over 3 dB through the use of the OEQ according to the present invention.

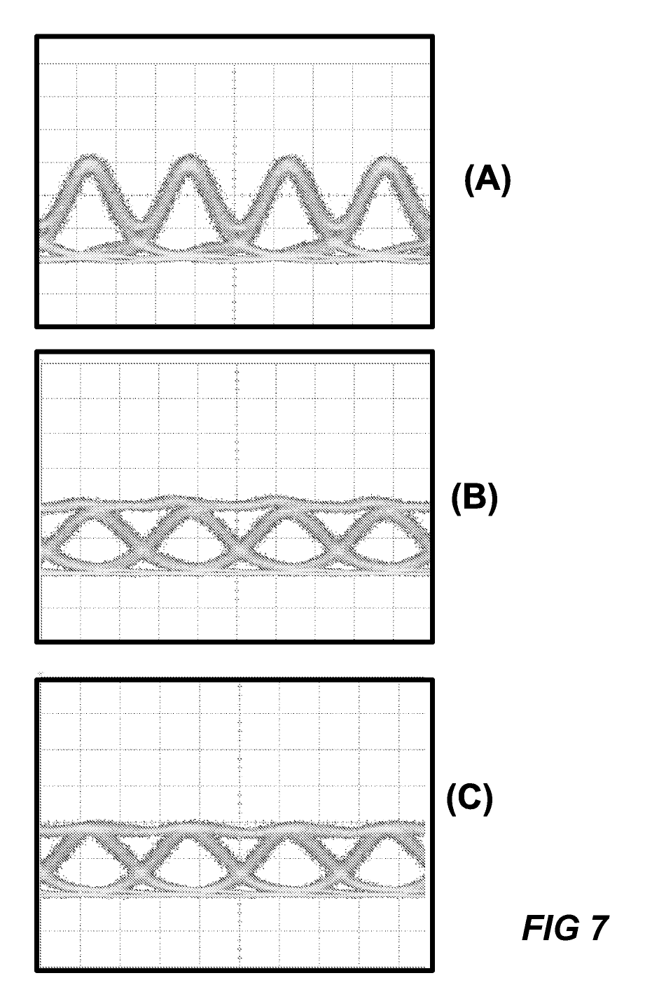

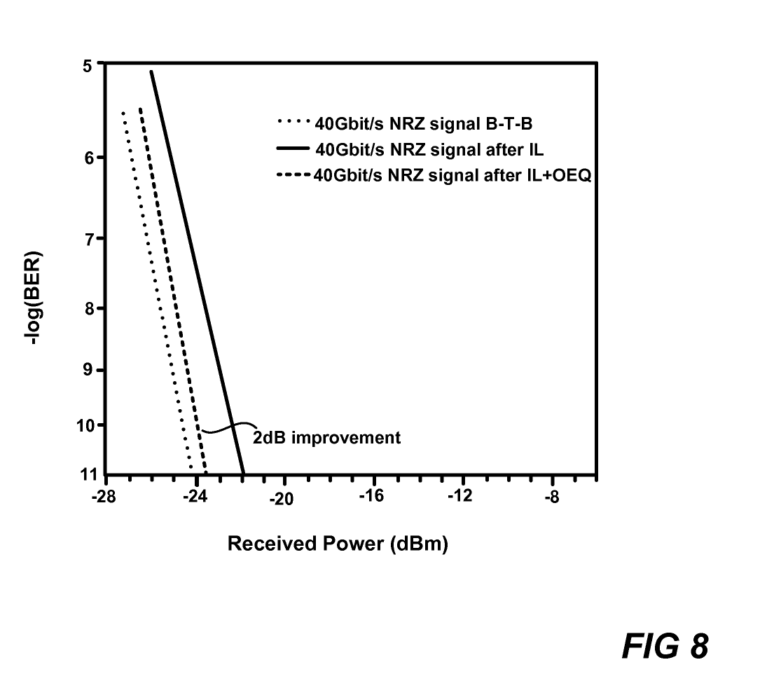

FIGS. 7(A), 7(B) and 7(C) show eye diagrams for 40 Gbit/s RZ signals. FIG. 8 is a graph which shows the BER performances for the 40 Gbit/s RZ signals. As can be appreciated by those skilled in the art, because each “1” in the RZ signals is almost returned to zero, the difference of the spectral distribution between the consecutive “1”s and isolated “1”s is reduced. Therefore the pattern effect is reduced as well when the signal is an RZ signal.

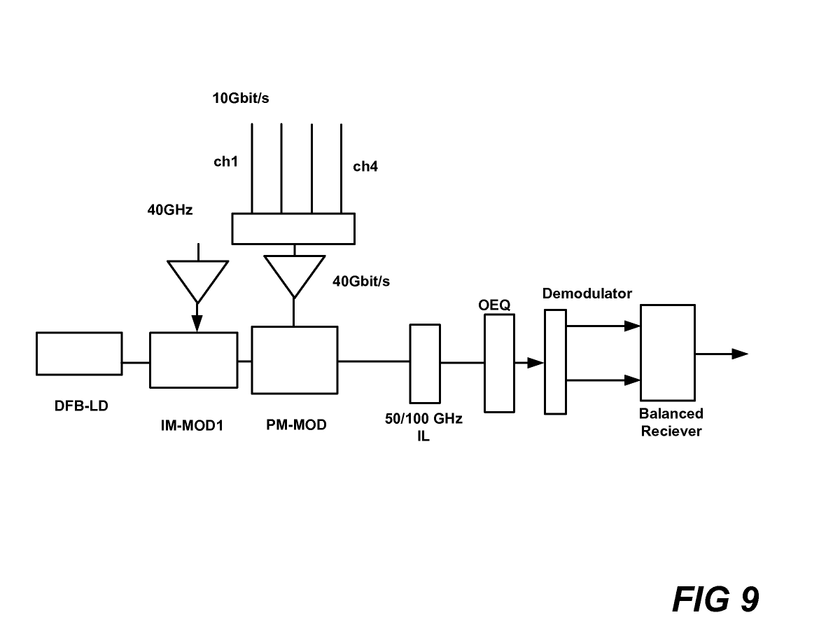

With reference now to FIG. 9, there it shows the experimental setup for using OEQ to reduce the pattern effect when the 40 Gbit/s phase modulated signals are passed through the 50/100 GHz optical interleaver. As shown in this FIG. 9, a 40 GHz phase modulator is used to realize O/E conversion and generate 40 Gbit/s optical signal. An optical demodulator having a FSR of 44.4 GHz is used to provide phase to intensity conversion. A balanced receiver is used to detect the constructive and deconstructive signals generated from the demodulator, and to provide O/E conversion. The converted electrical signals are de-multiplexed by using a 40 GHz de-multiplexer, and the de-multiplexed 10 Gbit/s signals are detected by a BER tester. Conveniently, a pre-amplifier is used for 40 Gbit/s signal detection in our experiment.

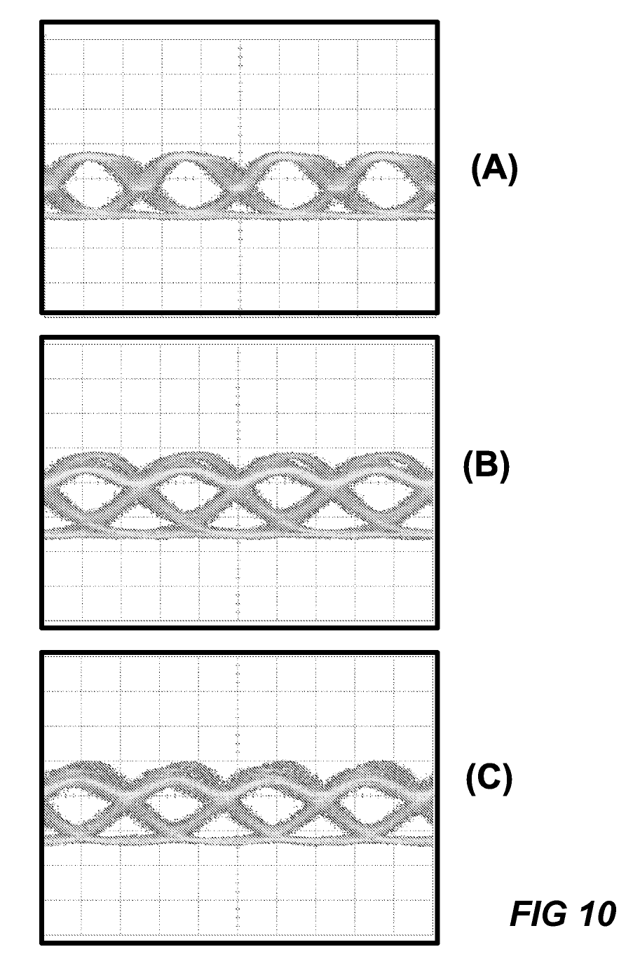

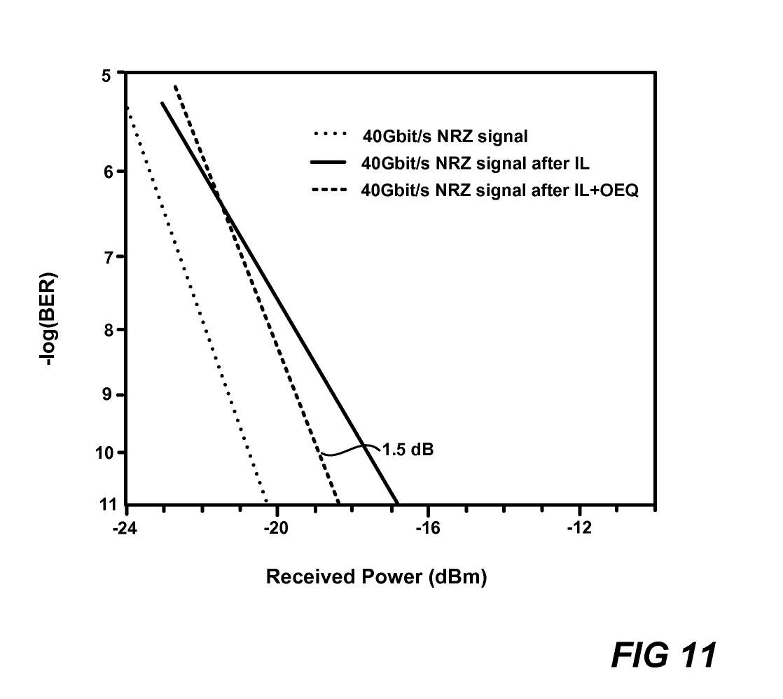

FIG. 10 and FIG. 11 shows the eye diagrams and BER performances of 40 Gbit/s NRZ-DPSK signals when the OEQ is employed to reduce the pattern effect. From these diagrams, one can see that the OEQ can be used to improve 1.5 dB receiver sensitivity for the 40 Gbit/s NRZ-DPSK signal.

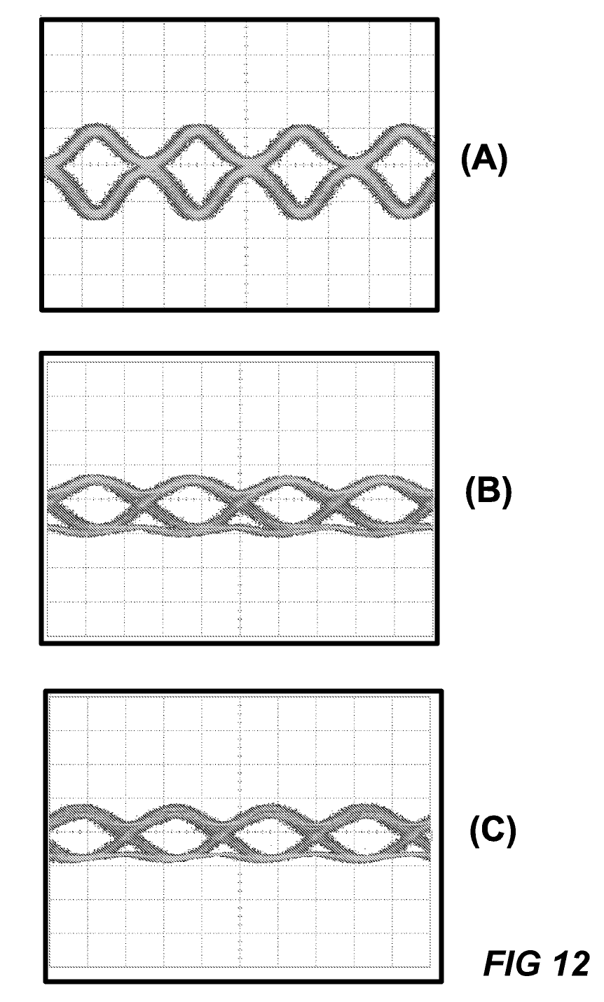

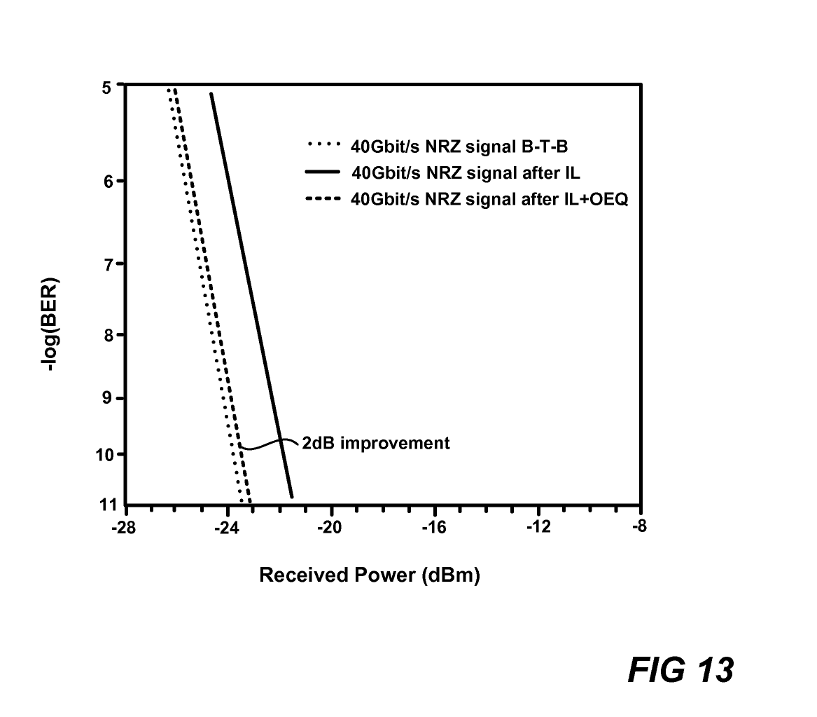

Numerical simulation results for these systems show that an optimal demodulator for the 40 Gbit/s phase modulated signal should be around 50 GHz FSR. Advantageously, if we use this optimized demodulator, the receiver sensitivity can be further improved. FIG. 12 and FIG. 13 show resulting eye diagrams and BER curves for RZ-DPSK signal when an OEQ is employed. FIG. 13 shows that 2 dB receiver sensitivity improvement has been realized.

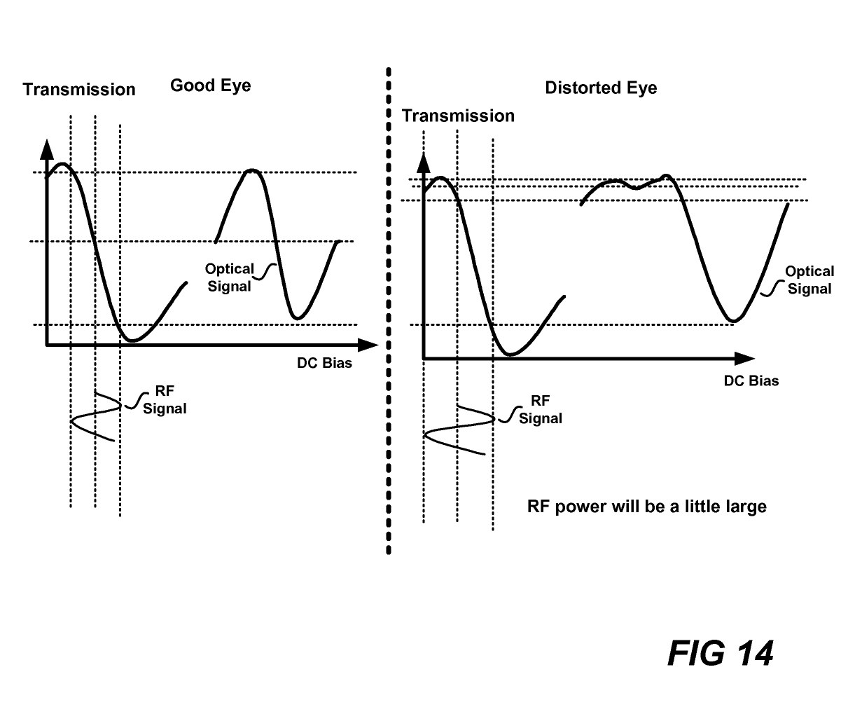

Turning now to FIG. 14, there it shows graphically the generation of a distorted input signal according to an aspect of the present invention. In order to generate a signal having a desirable shape, when the 40 Gbit/s electrical signals are used to drive the intensity modulator, the DC bias should be substantially ½ of the half-wave voltage. In this manner, the modulator is working in its linear area and therefore a good and symmetrical shape eye can be generated.

According to the present invention, the DC bias is adjusted such that the generated optical eye exhibits a distorted shape as shown in FIG. 14. When the DC bias is shifted to a small number, the eye will be distorted. In order to generate the same extinction ratio, the RF signal use to drive the modulator will be a little large for a distorted signal generation.

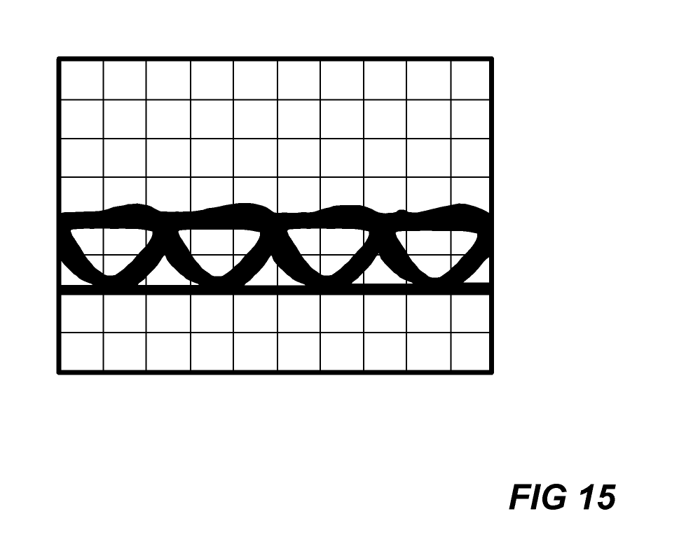

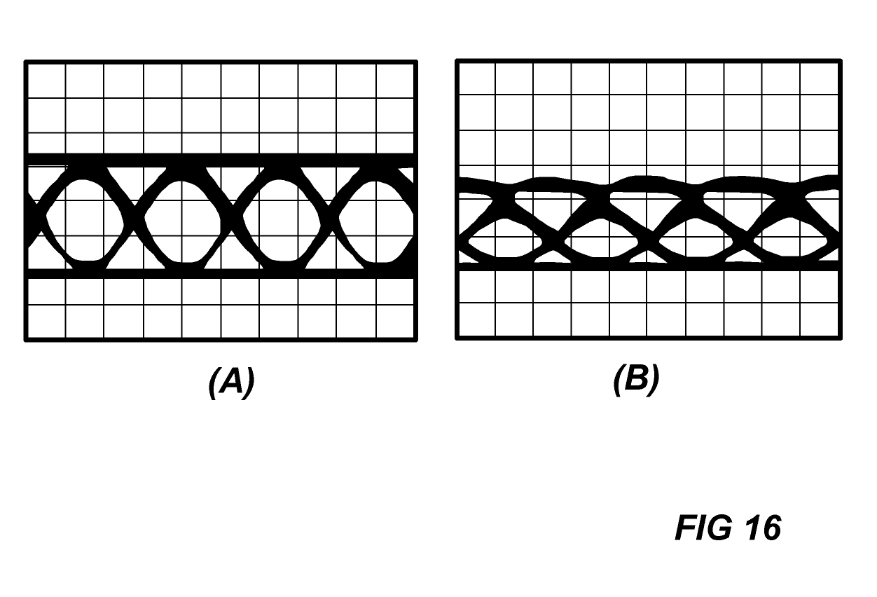

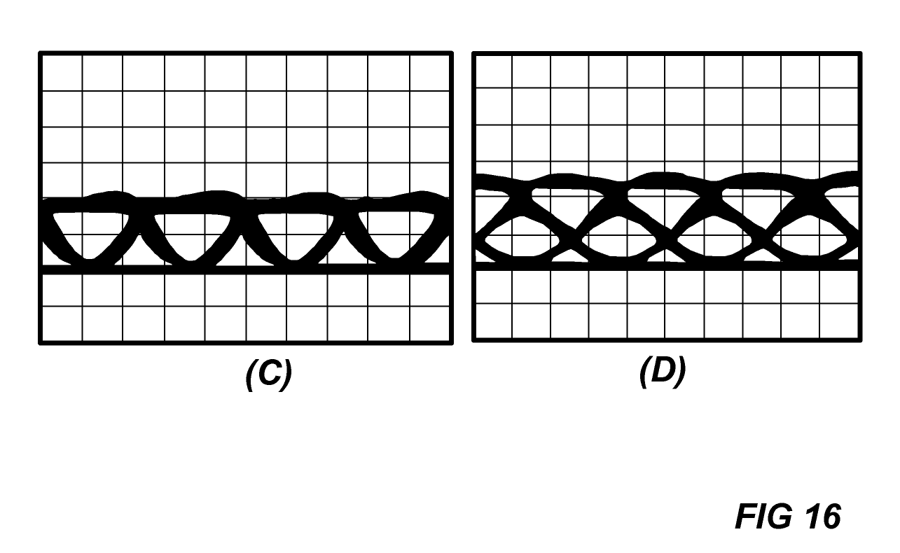

FIG. 15 shows a distorted eye generated by the technique according to the present invention. FIG. 16 shows the eye diagrams when a good or distorted 40 Gbit/s signals passing through a 50/200 GHz interleaver.

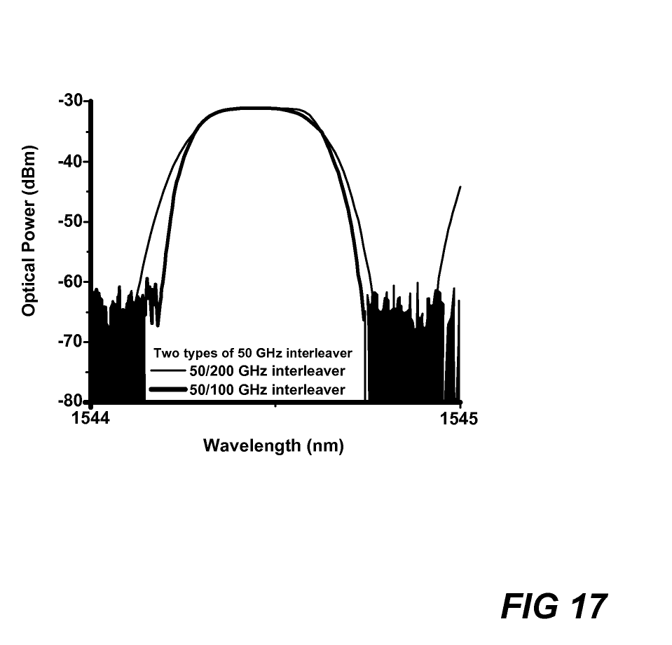

In this section, we use another 50 GHz interleaver exhibiting a slightly different transfer function compared to that used previously. The transfer functions of the two optical inter-leavers are shown graphically in FIG. 17.

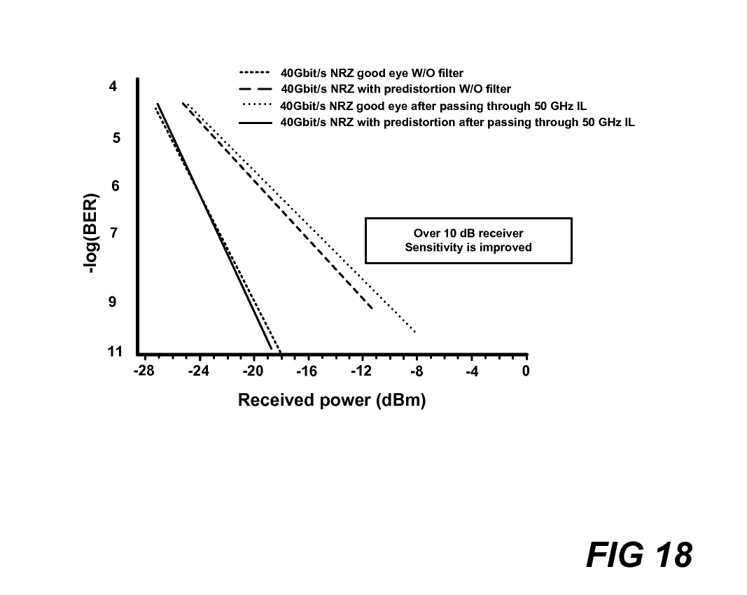

From this graph, it can see that the 50/200 GHz optical interleaver has a sharper transfer function, therefore the pattern effect will be more obvious. The BER curves shown in FIG. 18 verifies this conclusion. From these it can see that the signals with good shape have suffered strong pattern effect; therefore the receiver sensitivity is lower compared to these results shown previously in FIG. 6. When we use a distorted input eye, we can see that the receiver sensitivity has been enhanced. For the example shown herein, it has been enhanced by over 10 dB improvement.

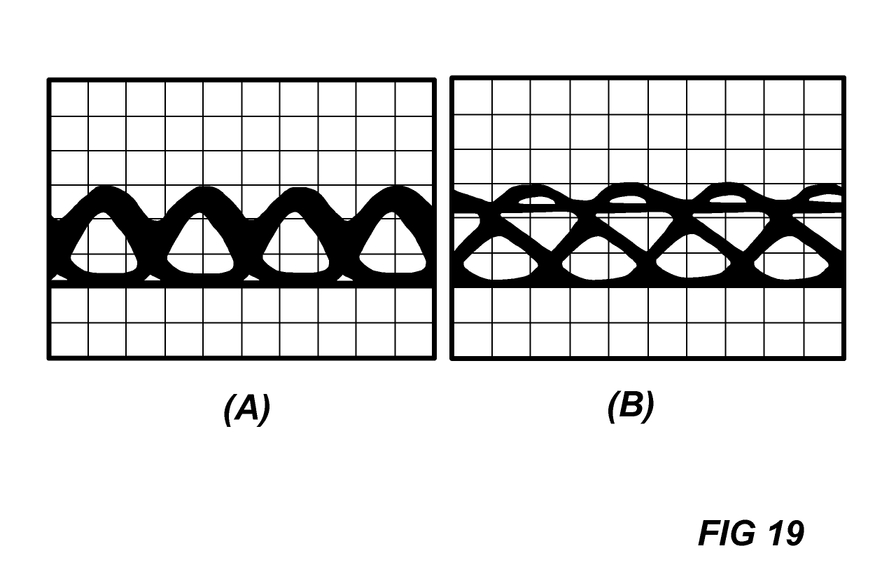

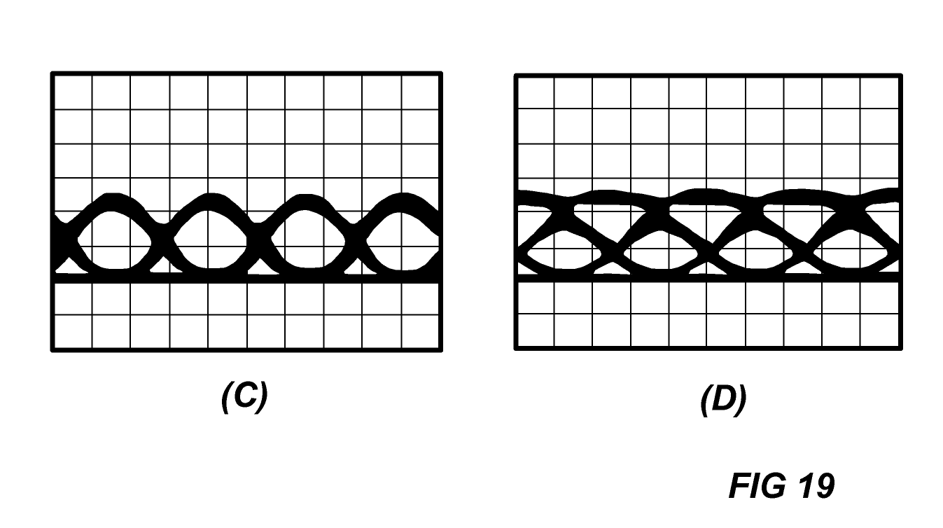

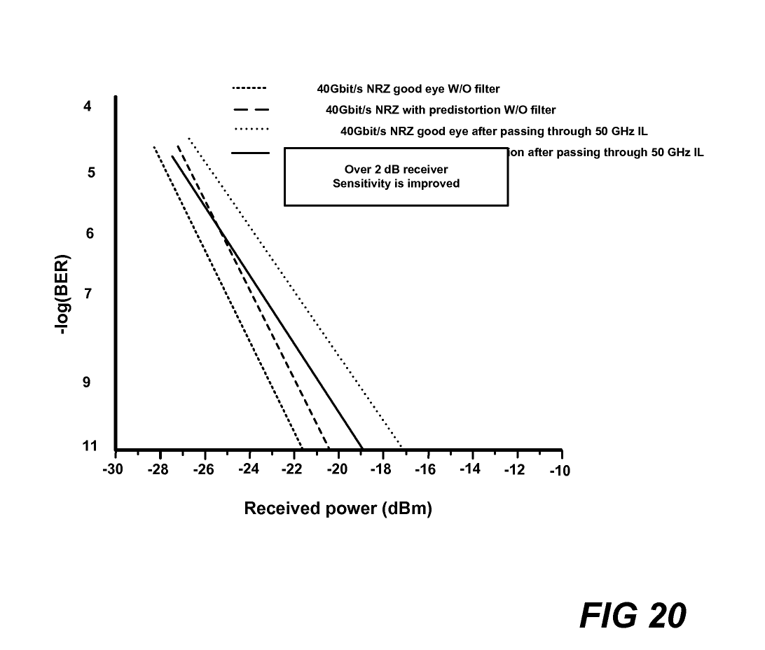

Our experimental results also show that the pre-distortion technique is also useful for a RZ intensity modulated signal. The experimental results are shown in FIG. 19 and FIG. 20. As can be observed from these figures, the pre-distortion technique of the present invention is useful for the intensity modulated RZ signal as well as receiver sensitivity improvement is around 2 dB due to the RZ signals have different spectral distribution compared to a NRZ signals as we discussed previously.

Other modifications and variations to the invention will be apparent to those skilled in the art. Accordingly, the invention should be only limited by the scope of the claims attached hereto.

What is claimed is:

1. A method for mitigating filter induced pattern effects in an optical signal comprising the steps of:
generating a substantially 40 Gb/s optical signal; and
interleaving the generated optical signals through the effect of a 50/100 Ghz optical interleaver; and
optically equalizing the interleaved signal to reduce any pattern effects.

2. The method of claim 1 wherein said 40 Gb/s optical signal is generated through the effect of two cascaded intensity modulators.

3. The method of claim 2 wherein said optical signal is a NRZ optical signal.
